(19) United States
(12) Patent Application Publication
(10) Pub. No.: US 2018/0172124 A1
(43) Pub. Date: Jun. 21, 2018

(54) ELECTRIC DRIVE AXLE WITH TRACTION AND VECTORING CAPABILITIES

(71) Applicant: American Axle & Manufacturing, Inc., Detroit, MI (US)

(72) Inventors: Paul J. Valente, Berkley, MI (US); John C. Hibbler, Lake Orion, MI (US); James P. Downs, South Lyon, MI (US)

(21) Appl. No.: 15/384,360

(22) Filed: Dec. 20, 2016

(51) Int. Cl. F16H 37/08; B60K 17/16; B60K 1/00; F16H 48/10; B60K 6/48; B60K 6/40; B60K 6/52

(52) U.S. Cl. CPC F16H 37/0813; B60K 17/16; B60K 1/00; B60K 6/52; B60K 6/48; B60K 6/40; F16H 48/10

(57) ABSTRACT

A drive module includes an electric motor, planetary differential, first, second, and third suns, first second and third planets, and first and second clutches disposed about an axis. The differential ring can be driven by the motor. The differential sun can be non-rotatably coupled to a first output. The differential carrier can be non-rotatably coupled to a second output. The first, second, and third planets can be supported by a common carrier for rotation about the first axis. The first sun can meshingly engage the first planets. The second sun can be non-rotatably coupled to the first output and meshingly engage the second planets. The third sun can be non-rotatably coupled to the differential carrier and meshingly engaged with the third planets. The first clutch can selectively permit or inhibit rotation of the common carrier. The second clutch can selectively permit or inhibit rotation of the first sun.

### FIELD

The present disclosure relates to an electric drive axle with traction and vectoring capabilities.

### BACKGROUND

This section provides background information related to the present disclosure which is not necessarily prior art.

Drive modules with one or more electric motors that are selectively operable to provide propulsion and/or torque vectoring capabilities are known in the art. For example, U.S. Pat. No. 8,998,765 discloses several drive modules that employ one or more motors to provide propulsion and/or torque vectoring capabilities to a pair of rear vehicle wheels in a vehicle having a pair of permanently driven front wheels. The drive modules of the '765 patent commonly employ a differential device having a differential gearset with bevel gears. While such configuration is suited for its intended purpose, it can be difficult in some situations to package a drive module of these types into some vehicles due to the overall length (in the lateral direction of the vehicle) of these drive modules. Accordingly, there remains a need in the art for a drive module that can be more easily packaged into a vehicle.

### SUMMARY

This section provides a general summary of the disclosure, and is not a comprehensive disclosure of its full scope or all of its features.

The present teachings provide for a drive module including a first output member, a second output member, an electric motor, a planetary differential, a common carrier, a first sun gear, a second sun gear, a third sun gear, a set of first planetary gears, a set of second planetary gears, a set of third planetary gears, a first clutch, and a second clutch. The first and second output members can be rotatable about a first axis. The electric motor can be disposed about the first axis and can include a motor output shaft configured to rotate about the first axis. The planetary differential can include a differential ring gear, a differential carrier, a differential sun gear, and a plurality of differential planet gears. The differential ring gear can be drivingly coupled to the motor output shaft to receive input torque from the motor output shaft. The differential sun gear can be coupled to the first output member for common rotation about the first axis. The differential carrier can be coupled to the second output member for common rotation about the first axis. The differential planet gears can be configured to receive input torque from the differential ring gear and to output differential torque to the differential carrier and the differential sun gear. The common carrier can be disposed about the first output member and can be configured to rotate about the first axis. The first sun gear can be disposed about the first output member and can be configured to rotate about the first axis. The second sun gear can be coupled to the first output member for common rotation about the first axis. The third sun gear can be coupled to the differential carrier for common rotation about the first axis. The first planet gears can be coupled to the common carrier for rotation about the first axis with the common carrier. Each first planet gear can be coupled to the common carrier for rotation relative to the common carrier about a corresponding axis of each first planet gear. The first planet gears can be meshingly engaged with the first sun gear. The second planet gears can be coupled to the common carrier for rotation about the first axis with the common carrier. Each second planet gear can be coupled to the common carrier for rotation relative to the common carrier about a corresponding axis of each second planet gear. The second planet gears can be meshingly engaged with the second sun gear. The third planet gears can be coupled to the common carrier for rotation about the first axis with the common carrier. Each third planet gear can be coupled to the common carrier for rotation relative to the common carrier about a corresponding axis of each third planet gear. The third planet gears can be meshingly engaged with the third sun gear. The first clutch can be coupled to the common carrier and operable in a first mode and a second mode. In the first mode, the first clutch can permit rotation of the common carrier. In the second mode, the first clutch can inhibit rotation of the common carrier. The second clutch can be coupled to the first sun gear and operable in a third mode and a fourth mode. In the third mode, the second clutch can permit rotation of the first sun gear. In the fourth mode, the second clutch can inhibit rotation of the first sun gear.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a vehicle having a drive module constructed in accordance with the teachings of the present disclosure;

FIG. 2 diagrammatically illustrates a cross-sectional view of the drive module of FIG. 1; and

FIG. 3 diagrammatically illustrates a cross-sectional view of a drive module of a second construction.

Corresponding reference numerals indicate corresponding parts throughout the several views of the drawings.

### DETAILED DESCRIPTION

Example embodiments will now be described more fully with reference to the accompanying drawings.

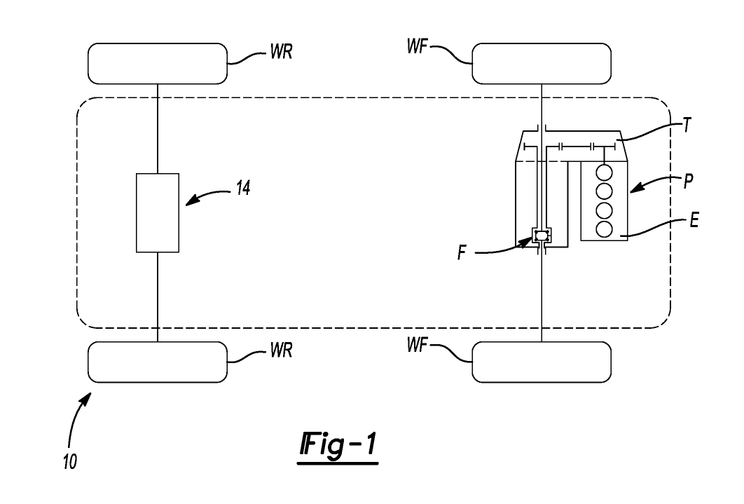

With reference to FIG. 1 of the drawings, an exemplary vehicle 110 is depicted with a power train P, a conventional front-wheel drive drivetrain F that can be driven by the power train P, and a drive module 14 that is constructed in accordance with the teachings of the present disclosure. The power train P can include an internal combustion engine E and a transmission T that can be driven by the engine E. The transmission T can output rotary power to the front-wheel drivetrain F, which can transmit rotary power to drive a pair of front vehicle wheels WF. The drive module 14 can be selectively operated to transmit rotary power to a pair of rear vehicle wheels WR.

While the drive module 14 of the example shown is a rear drive module of an all-wheel-drive vehicle, the drive module 14 can utilized in other configurations, such as front wheel drive only, rear wheel drive only, 4-wheel drive, fully electric, or other hybrid configurations for example. One such example can include the drive module 14 providing rotary power to the front wheels WF, while the power train P can provide power to the rear wheels WR. In another example, the internal combustion engine E can be replaced with an electric motor. Alternatively, the drive module 14 can provide power to the rear wheels WR or to the front wheels WF while the other set of wheels are not configured to be driven. Similarly, one drive module 14 can be drivingly coupled to the front or rear wheels WF, WR while another one of the drive modules 14 can power the other set of wheels.

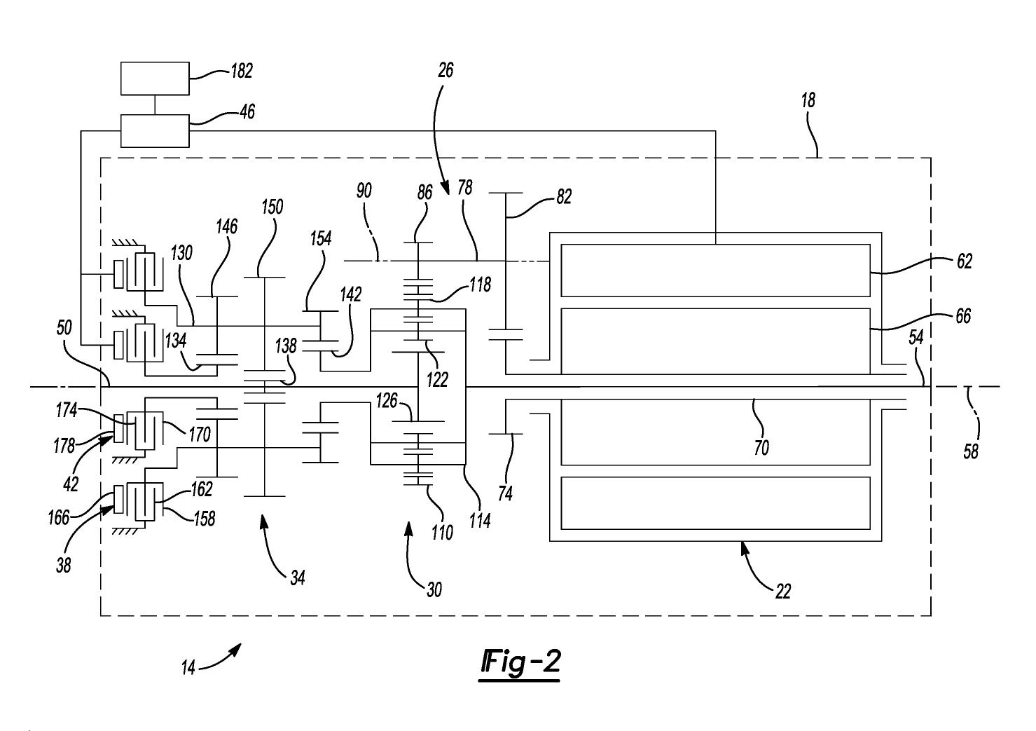

With additional reference to FIG. 2, the drive module 14 is illustrated in greater detail. In the example provided, the drive module 14 can include a housing 18, an electric motor 22, a reduction gearset 26, a differential 30, a vectoring gearset 34, a first clutch 38, a second clutch 42, a control module 46, a first output member 50, and a second output member 54. In the example provided, the electric motor 22, the reduction gearset 26, the differential 30, the vectoring gearset 34, the first clutch 38, and the second clutch 42 can be disposed within the housing 18. The first output member 50 can be disposed about a first axis 58 and supported within the housing 18 for rotation relative to the housing 18. The first output member 50 can extend out from the housing 18 and can be drivingly coupled to one of a set of drive wheels (e.g., the left or right one of the rear wheels WR of FIG. 1) to provide rotational power thereto. The second output member 54 can extend out from the housing 18 and can be drivingly coupled to the other one of the set of drive wheels (e.g., the right or left one of the rear wheels WR of FIG. 1) to provide rotational power thereto.

The electric motor 22 can include a stator 62, a rotor 66, and a hollow motor output shaft 70. The stator 62 can be fixedly coupled to the housing 18. The rotor 66 can be rotatable relative to the stator 62 and can be fixedly coupled to the motor output shaft 70 for common rotation about the first axis 58. The motor output shaft 70 can be disposed about the second output member 54, which can extend axially through the motor output shaft 70 such that the electric motor 22 can be disposed about the second output member 54. The motor output shaft 70 can be drivingly coupled to the differential 30 via the reduction gearset 26.

The reduction gearset 26 can be configured to reduce the rotational speed from the motor output shaft 70 to the differential 30. In the example provided, the reduction gearset 26 includes a motor output gear 74, a jack shaft 78, a first reduction gear 82, and a second reduction gear 86, though other reduction gearsets can be used. The jack shaft 78 can be a shaft supported within the housing 18 for rotation relative to the housing 18 about a second axis 90 that can be parallel to and offset from the first axis 58. The first reduction gear 82 can be fixedly coupled to the jack shaft 78 for common rotation about the second axis 90 with the jack shaft 78. The second reduction gear 86 can be fixedly coupled to the jack shaft 78 for common rotation about the second axis 90 with the jack shaft 78 and first reduction gear 82.

The motor output gear 74 can be meshingly engaged with the first reduction gear 82. The second reduction gear 86 can be meshingly engaged to an input 110 of the differential 30, as described below. In the example provided, the motor output gear 74, the first reduction gear 82, and the second reduction gear 86 are spur gears, though other types of gears can be used, such as helical gears for example. In the example provided, the motor output gear 74 can have a lesser number of gear teeth than the first reduction gear 82, the second reduction gear 86 can have a lesser number of gear teeth than the first reduction gear 82, and the input 110 of the differential 30 can have a greater number of gear teeth than the second reduction gear 86. In the example provided, the reduction gear ratio between the motor output gear 74 and the first reduction gear 82 can be approximately 3:1 and the reduction gear ratio between the second reduction gear 86 and the input 110 of the differential 30 can be approximately 3:1, such that the total speed reduction can be approximately 9:1, though other gear ratios can be used.

The differential 30 can be a planetary differential configured to receive input torque from the reduction gearset 26 and to output differential torque to the first and second output members 50, 54. The differential 30 can include the input 110, a differential carrier 114, a set of first differential planet gears 118, a set of second differential planet gears 122, and a differential sun gear 126. The input 110 of the differential 30 can be a ring gear disposed about the first axis 58 and supported within the housing for rotation about the first axis 58. The input 110 of the differential 30 can have external teeth meshingly engaged with the second reduction gear 86. The input 110 of the differential 30 can have internal teeth meshingly engaged to the first differential planet gears 118.

The differential carrier 114 can be disposed about the first axis 58 and supported within the housing 18 for rotation about the first axis 58. The differential carrier 114 can be fixedly coupled to the second output member 54 for common rotation about the first axis 58 with the second output member 54. The second output member 54 can extend from a side of the differential 30 that is proximate to the motor 22.

The set of first differential planet gears 118 can include a plurality of the first differential planet gears 118. Each of the first differential planet gears 118 can be coupled to the differential carrier 114 for common rotation about the first axis 58 with the differential carrier 114 and for rotation relative to the differential carrier 114 about the corresponding axis of each first differential planet gear 118, which can be parallel to and offset from the first and second axes 58, 90. The first differential planet gears 118 can be circumferentially spaced about the first axis 58 and can be equally spaced thereabout. The first differential planet gears 118 can be disposed radially between the input 110 of the differential 30 and the differential sun gear 126. Each of the first differential planet gears 118 can be meshingly engaged with the internal teeth of the input 110 of the differential 30.

The set of second differential planet gears 122 can include a plurality of the second differential planet gears 122. Each of the second differential planet gears 122 can be coupled to the differential carrier 114 for common rotation about the first axis 58 with the differential carrier 114 and for rotation relative to the differential carrier 114 about the corresponding axis of each second differential planet gear 122, which can be parallel to and offset from the first and second axes 58, 90 and the corresponding axes of the first differential planet gears 118. The second differential planet gears 122 can be circumferentially spaced about the first axis 58 and can be equally spaced thereabout. The second differential planet gears 122 can be disposed radially between the input 110 of the differential 30 and the differential sun gear 126. Each of the second differential planet gears 122 can be meshingly engaged with the differential sun gear 126 and a corresponding one of the first differential planet gears 118.

The differential sun gear 126 can be disposed about the first axis 58, radially inward of the first and second differential planet gears 118, 122. The differential sun gear 126 can be fixedly coupled to the first output member 50 for common rotation about the first axis 58 with the first output member 50. The first output member 50 can extend from a side of the differential 30 that is opposite the motor 22. The differential sun gear 126 can have external teeth that can be meshingly engaged with the second differential planet gears 122.

The vectoring gearset 34 can include a common carrier 130, a first sun gear 134, a second sun gear 138, a third sun gear 142, a set of first planet gears 146, a set of second planet gears 150, and a set of third planet gears 154. The common carrier 130 can be disposed about the first output member 50 and supported for rotation about the first axis 58 relative to the housing 18 and the first output member 50.

The first sun gear 134 can be disposed about the first output member 50 and supported for rotation about the first axis 58 relative to the common carrier 130 and the first output member 50. The second sun gear 138 can be disposed about the first output member 50 and fixedly coupled to the first output member 50 for common rotation about the first axis 58 with the first output member 50. The third sun gear 142 can be disposed about the first output member 50 and fixedly coupled to the differential carrier 114 for common rotation about the first axis 58 with the differential carrier 114. In the example provided, the differential 30 is axially between the vectoring gearset 34 and the motor 22. In the example provided, the third sun gear 142 is axially between the second sun gear 138 and the differential 30 and the second sun gear 138 is axially between the first sun gear 134 and the third sun gear 142.

In the example provided, the differential sun gear 126 can have a greater number of teeth than the third sun gear 142, the third sun gear 142 can have a greater number of teeth than the first sun gear 134, and the first sun gear 134 can have a greater number of teeth than the second sun gear 138, though other configurations can be used. In one example configuration, the differential sun gear 126 can have 36 teeth, the first sun gear 134 can have 32 teeth, the second sun gear 138 can have 30 teeth, and the third sun gear 142 can have 34 teeth, though other configurations can be used.

The set of first planet gears 146 can include a plurality of the first planet gears 146. Each of the first planet gears 146 can be coupled to the common carrier 130 for common rotation about the first axis 58 with the common carrier 130 and for rotation relative to the common carrier 130 about the corresponding axis of each first planet gear 146, which can be parallel to and offset from the first and second axes 58, 90. The first planet gears 146 can be circumferentially spaced about the first axis 58 and can be equally spaced thereabout. The first planet gears 146 can be disposed radially outward of the first sun gear 134 and can meshingly engage the first sun gear 134.

The set of second planet gears 150 can include a plurality of the second planet gears 150. Each of the second planet gears 150 can be coupled to the common carrier 130 for common rotation about the first axis 58 with the common carrier 130 and for rotation relative to the common carrier 130 about the corresponding axis of each second planet gear 150, which can be parallel to and offset from the first and second axes 58, 90. The second planet gears 150 can be circumferentially spaced about the first axis 58 and can be equally spaced thereabout. The second planet gears 150 can be disposed radially outward of the second sun gear 138 and can meshingly engage the second sun gear 138.

The set of third planet gears 154 can include a plurality of the third planet gears 154. Each of the third planet gears 154 can be coupled to the common carrier 130 for common rotation about the first axis 58 with the common carrier 130 and for rotation relative to the common carrier 130 about the corresponding axis of each third planet gear 154, which can be parallel to and offset from the first and second axes 58, 90. The third planet gears 154 can be circumferentially spaced about the first axis 58 and can be equally spaced thereabout. The third planet gears 154 can be disposed radially outward of the third sun gear 142 and can meshingly engage the third sun gear 142.

The first clutch 38 can be configured to selectively prevent rotation of the common carrier 130. In the example provided, the first clutch 38 is configured to selectively couple the common carrier 130 to the housing 18. In the example provided, the first clutch 38 is a friction clutch, though other types of clutches or coupling mechanisms can be used, such as a sleeve or a dog clutch for example. The first clutch 38 can include a plurality of first friction plates 158, a plurality of second friction plates 162, and a first actuator 166. The first friction plates 158, the second friction plates 162, and the first actuator 166 can be annular in shape and disposed about the first axis 58 and the first output member 50.

The first friction plates 158 can be coupled to the common carrier 130 for common rotation about the first axis 58 with the common carrier 130 while being axially slidable along the first axis 58. The second friction plates 162 can be interleaved with the first friction plates 158 and can be non-rotatably coupled to the housing 18, while being axially slidable along the first axis 58. In the example provided, the first and second friction plates 158, 162 can be axially biased apart from one another, such as by a spring (not specifically shown). The first actuator 166 can be any suitable actuator (e.g., a hydraulic actuator, a ball-ramp actuator, a screw-type actuator, solenoid actuator), configured to selectively apply an axial force to compress the first and second friction plates 158, 162 to inhibit rotation of the common carrier 130.

In the example provided, when the first actuator 166 is in a fully actuated state, the first and second friction plates 158, 162 can be fully engaged and the common carrier 130 can be non-rotatably coupled to the housing 18 to prevent rotation of the common carrier 130 about the first axis 58. The first actuator 166 can be configured to selectively modulate the compression force on the first and second friction plates 158, 162 to control an amount of rotational slip therebetween. In this way, when the first actuator 166 is operated in an intermediate state, or modulating state, rotation of the common carrier 130 can be inhibited, while not being fully prevented. In the example provided, when the first actuator 166 is operated in a deactivated state, the first and second friction plates 158, 162 are not engaged and the common carrier 130 is free to rotate about the first axis 58.

The second clutch 42 can be configured to selectively prevent rotation of the first sun gear 134. In the example provided, the second clutch 42 is configured to selectively couple the first sun gear 134 to the housing 18. In the example provided, the second clutch 42 is a friction clutch, though other types of clutches or coupling mechanisms can be used, such as a sleeve or a dog clutch for example. The second clutch 42 can include a plurality of third friction plates 170, a plurality of fourth friction plates 174, and a second actuator 178. The third friction plates 170, the fourth friction plates 174, and the second actuator 178 can be annular in shape and disposed about the first axis 58 and the first output member 50.

The third friction plates 170 can be coupled to the first sun gear 134 for common rotation about the first axis 58 with the first sun gear 134 while being axially slidable along the first axis 58. The fourth friction plates 174 can be interleaved with the third friction plates 170 and can be non-rotatably coupled to the housing 18, while being axially slidable along the first axis 58. In the example provided, the third and fourth friction plates 170, 174 can be axially biased apart from one another, such as by a spring (not specifically shown). The second actuator 178 can be any suitable actuator (e.g., a hydraulic actuator, a ball-ramp actuator, a screw-type actuator, solenoid actuator), configured to selectively apply an axial force to compress the third and fourth friction plates 170, 174 to inhibit rotation of the first sun gear 134.

In the example provided, when the second actuator 178 is in a fully actuated state, the third and fourth friction plates 170, 174 can be fully engaged and the first sun gear 134 can be non-rotatably coupled to the housing 18 to prevent rotation of the first sun gear 134 about the first axis 58. The second actuator 178 can be configured to selectively modulate the compression force on the third and fourth friction plates 170, 174 to control an amount of rotational slip therebetween. In this way, when the second actuator 178 is operated in an intermediate state, or modulating state, rotation of the first sun gear 134 can be inhibited, while not being fully prevented. In the example provided, when the second actuator 178 is operated in a deactivated state, the third and fourth friction plates 170, 174 are not engaged and the first sun gear 134 is free to rotate about the first axis 58.

The control module 46 (e.g., a control circuit) can be in electrical communication with the first and second actuators 166, 178 to selectively control operation of the first and second actuators 166, 178.

In operation, the drive module 14 can be operated in an open mode, wherein the first and second clutches 38, 42 are not activated. In the example provided, when the drive module 14 is operated in the open mode, the differential 30 acts as an open differential and differential torque is output to the first and second output members 50, 54.

The control module 46 can selectively operate the first and second clutches 38, 42 to provide torque vectoring of the first and second output members 50, 54. In the example provided, when more rotational speed is required at the first output member 50 than the second output member 54, the control module 46 can activate the first actuator 166 and maintain the second actuator 178 in the deactivated state, such as to engage the first clutch 38 and inhibit rotation of the common carrier 130, while permitting rotation of the first sun gear 134. As a result, the first output member 50 rotates faster than the second output member 54.

In the example provided, when more rotational speed is required at the second output member 54 than the first output member 50, the control module 46 can activate the second actuator 178 and maintain the first actuator 166 in the deactivated state, such as to engage the second clutch 42 and inhibit rotation of the first sun gear 134, while permitting rotation of the common carrier 130. As a result, the second output member 54 rotates faster than the first output member 50.

Additionally, the control module 46 can be in communication with the electric motor 22 and a power source 182 (e.g., the vehicle's battery) to control operation of the electric motor 22. In some situations, the first and second output members 50, 54 can back-drive the differential 30, which can drive the electric motor 22. The control module 46 can control the electric motor 22 to provide regenerative braking of the first and second output members 50, 54 while charging the power source 182.

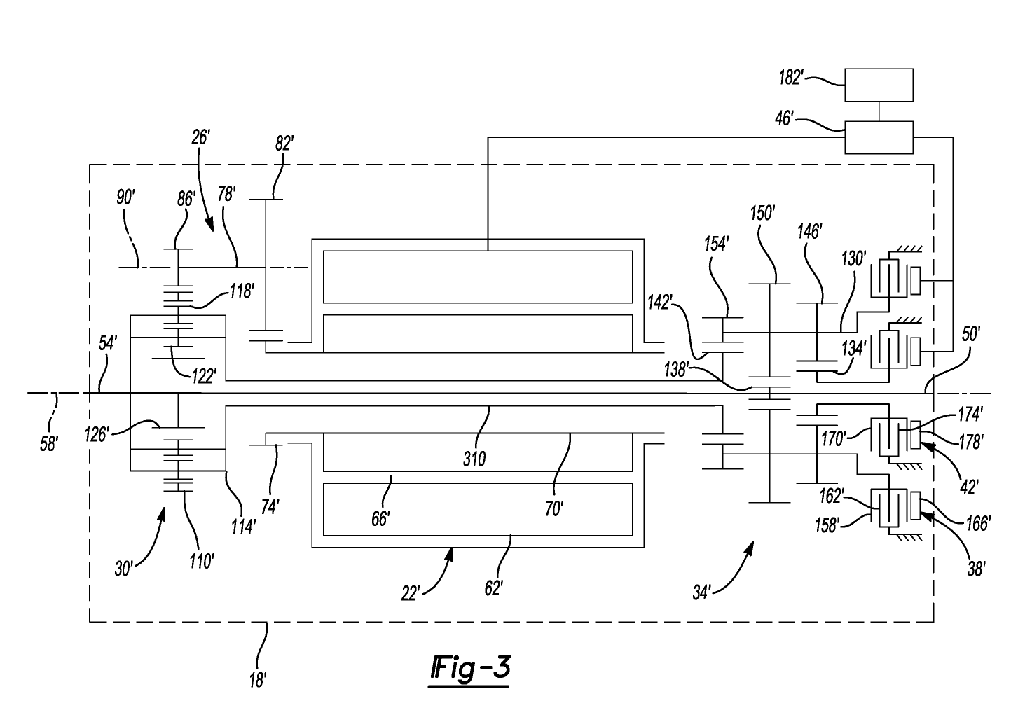

With additional reference to FIG. 3, a drive module 14′ of a second construction is illustrated. The drive module 14′ can be similar to the drive module 14 described above with reference to FIG. 2, except as otherwise shown or described herein. Elements of the drive module 14′ indicated by primed reference numerals can be similar to the elements of the drive module 14 indicated with similar, non-primed reference numerals, described above. In the example provided in FIG. 3, the electric motor 22′ can be located axially between the differential 30′ and the vectoring gearset 34′. The first output member 50′ can extend from a side of the differential 30′ proximate to the electric motor 22′, and the second output member 54′ can extend from a side of the differential 30′ distal to the electric motor 22′. The motor output shaft 70′ can be disposed about the first output member 50′ and an intermediate member 310 that can be non-rotatably coupled to the differential carrier 114′ and the third sun gear 142′. The intermediate member 310 can be a hollow tube that can extend from the differential carrier 114′ coaxially through the electric motor 22′ to the third sun gear 142′. The intermediate member 310 can be disposed about the first output member 50′.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A drive module for a vehicle, the drive module comprising:
a first output member and a second output member, the first and second output members being rotatable about a first axis;
an electric motor disposed about the first axis and including a motor output shaft configured to rotate about the first axis;
a planetary differential including a differential ring gear, a differential carrier, a differential sun gear, and a plurality of differential planet gears, the differential ring gear being drivingly coupled to the motor output shaft to receive input torque from the motor output shaft, the differential sun gear being coupled to the first output member for common rotation about the first axis, the differential carrier being coupled to the second output member for common rotation about the first axis, the differential planet gears being configured to receive input torque from the differential ring gear and to output differential torque to the differential carrier and the differential sun gear;
a common carrier disposed about the first output member and configured to rotate about the first axis;
a first sun gear disposed about the first output member and configured to rotate about the first axis;
a second sun gear coupled to the first output member for common rotation about the first axis;
a third sun gear coupled to the differential carrier for common rotation about the first axis;
a set of first planet gears coupled to the common carrier for rotation about the first axis with the common carrier, each first planet gear being coupled to the common carrier for rotation relative to the common carrier about a corresponding axis of each first planet gear, the first planet gears being meshingly engaged with the first sun gear;
a set of second planet gears coupled to the common carrier for rotation about the first axis with the common carrier, each second planet gear being coupled to the common carrier for rotation relative to the common carrier about a corresponding axis of each second planet gear, the second planet gears being meshingly engaged with the second sun gear;
a set of third planet gears coupled to the common carrier for rotation about the first axis with the common carrier, each third planet gear being coupled to the common carrier for rotation relative to the common carrier about a corresponding axis of each third planet gear, the third planet gears being meshingly engaged with the third sun gear;
a first clutch coupled to the common carrier and operable in a first mode wherein the first clutch permits rotation of the common carrier, and a second mode wherein the first clutch inhibits rotation of the common carrier; and
a second clutch coupled to the first sun gear and operable in a third mode wherein the second clutch permits rotation of the first sun gear, and a fourth mode wherein the second clutch inhibits rotation of the first sun gear.

2. The drive module of claim 1, wherein the motor output shaft is disposed about the second output member.

3. The drive module of claim 1, wherein the motor output shaft is disposed about the first output member.

4. The drive module of claim 1, further comprising a reduction gearset drivingly coupled to the motor output shaft and the differential ring gear to transmit torque therebetween, the reduction gearset being configured to rotate the differential ring gear at a rotational speed that is less than a rotational speed of the motor output shaft.

5. The drive module of claim 4, wherein the reduction gearset includes a motor output gear, a jack shaft, a first reduction gear, and a second reduction gear, the motor output gear being coupled to the motor output shaft for common rotation about the first axis, the jack shaft being rotatably disposed about a second axis that is parallel to and offset from the first axis, the first reduction gear being non-rotatably coupled to the jack shaft for common rotation about the second axis and being meshingly engaged with the motor output gear, the second reduction gear being non-rotatably coupled to the jack shaft for common rotation about the second axis and being meshingly engaged with the differential ring gear.

6. The drive module of claim 1, wherein the plurality of differential planet gears includes a set of first differential planet gears and a set of second differential planet gears, each of the first differential planet gears is meshingly engaged to the differential ring gear and a corresponding one of the second differential planet gears, each of the second differential planet gears is meshingly engaged to the differential sun gear, wherein the first differential planet gears are coupled to the differential carrier for rotation about the first axis with the differential carrier and each first differential planet gear is coupled to the differential carrier for rotation relative to the differential carrier about a corresponding axis of each first differential planet gear, wherein the second differential planet gears are coupled to the differential carrier for rotation about the first axis with the differential carrier and each second differential planet gear is coupled to the differential carrier for rotation relative to the differential carrier about a corresponding axis of each second differential planet gear.

7. The drive module of claim 1, wherein the first clutch includes a first set of friction plates and a second set of friction plates, the first set of friction plates being non-rotatably coupled to the common carrier, the second set of friction plates being non-rotatably coupled to a housing of the drive module.

8. The drive module of claim 1, wherein the second clutch includes a first set of friction plates and a second set of friction plates, the first set of friction plates being non-rotatably coupled to the first sun gear, the second set of friction plates being non-rotatably coupled to a housing of the drive module.

9. The drive module of claim 1, wherein the first sun gear has a greater number of gear teeth than the second sun gear, and wherein the third sun gear has a greater number of gear teeth than the first sun gear.

10. The drive module of claim 1, further comprising a housing, the electric motor, the planetary differential, the common carrier, the first sun gear, the second sun gear, the third sun gear, the first planet gears, the second planet gears, and the third planet gears being disposed within the housing.

11. The drive module of claim 10, wherein the first and second clutches are disposed within the housing.

12. The drive module of claim 1, further comprising a control module in electrical communication with the electrical motor, the first clutch and the second clutch and configured to control operation of the electrical motor, the first clutch and the second clutch.

13. The drive module of claim 1, wherein the differential is axially between the electric motor and the first, second, and third sun gears.

14. The drive module of claim 1, wherein the electric motor is axially between the differential and the first, second, and third sun gears.
